(19) United States
(12) Patent Application Publication
(10) Pub. No.: US 2014/0261899 A1
(43) Pub. Date: Sep. 18, 2014

(54) AMORPHOUS ALLOY NEGATIVE ELECTRODE COMPOSITIONS FOR LITHIUM-ION ELECTROCHEMICAL CELLS

(71) Applicant: 3M INNOVATIVE PROPERTIES COMPANY, St. Paul, MN (US)

(72) Inventors: Dinh B. Le, St. Paul, MN (US); Jeffrey R. Dahn, Halifax (CA); Richard A. Dunlap, Musquodoboit Harbour (CA); Mahdi Abdul Fattah Al-Maghrabi, Yanbu Industrial City (SA)

(21) Appl. No.: 14/350,367

(22) PCT Filed: Oct. 9, 2012
(86) PCT No.: PCT/US12/59284

§ 371 Date: Apr. 8, 2014

Related U.S. Application Data
(60) Provisional application No. 61/545,368, filed on Oct. 10, 2011.

(51) Int. Cl. H01M 4/38

(52) U.S. Cl. CPC H01M 4/386
USPC 148/403; 241/25

(57) ABSTRACT

Negative electrode compositions for use in a lithium-ion electrochemical cell are provided that has the formula, SiₓSn_{q}M_{y}C_{z}, wherein q, x, y, and z represent mole fractions, q, x, and z are greater than zero and M is one or more transition metals. The provided electrode compositions are amorphous and can be made by sputtering or ball milling. Typically, 0.50≦x≦0.83, 0.02≦y≦0.10, 0.25≦z≦0.35, and 0.02≦q≦0.05. Electrodes made using the provided electrode compositions can include a binder than can be lithium polyacrylate.

### FIELD

The present disclosure relates to alloy anodes for use in lithium-ion electrochemical cells.

### BACKGROUND

Lithium-ion electrochemical cells generally have a negative electrode, a positive electrode, and an electrolyte. Graphite-based anodes have been used in lithium-ion electrochemical cells. Silicon has nearly three times the theoretical volumetric capacity for lithium metal as compared to graphite; hence, silicon is an attractive negative electrode material for use in lithium-ion electrochemical cells. However, the volumetric expansion of silicon when it is fully lithiated is typically too large to be tolerated by the conventional binder materials used to make composite electrodes, leading to failure of the anode during cycling of the electrochemical cell.

Metal alloys that include silicon are useful as negative electrodes for lithium-ion electrochemical cells. These alloy-type negative electrodes generally exhibit higher capacities relative to intercalation-type anodes such as graphite. One problem with such alloys, however, is that they often exhibit relatively poor cycle life and poor coulombic efficiency due to fragmentation of the alloy particles during the expansion and contraction associated with compositional changes in the alloys. Typically, the metal alloys include crystalline and amorphous phases.

### SUMMARY

Non-uniform volumetric expansion is observed when crystalline active metal elements or alloys are lithiated. The morphological form of active metal elements or alloys is a function of their chemical composition and the method of making them. Typically, alloy negative electrode materials have both amorphous phases and nano- or microcrystalline phases. The provided alloy negative electrode compositions are completely amorphous and thus undergo less internal stress than conventional alloy-type negative electrode compositions.

In one aspect, a negative electrode composition for a lithium-ion electrochemical cell is provided that includes an alloy having the formula SiₓSn_{q}M_{y}C_{z}, wherein q, x, y, and z represent mole fractions, q, x, and z are greater than zero, and M is one or more transition metals, wherein the electrode composition is amorphous. In some embodiments the transition metals can be selected from manganese, molybdenum, niobium, tungsten, tantalum, iron, copper, titanium, vanadium, chromium, nickel, cobalt, zirconium, yttrium, and combinations thereof. In other embodiments the transition metals can be iron, titanium, and combinations thereof. In some embodiments, 0.50≦x≦0.83, 0.55≦x≦0.83 or even 0.60≦x≦0.83. In some embodiments, 0≦y≦0.15. In other embodiments, 0.02≦y≦0.05. In some embodiments, 0.18≦z≦0.50. In other embodiments, 0.25≦z≦0.35. In some embodiments, 0≦q≦0.45. In other embodiments, 0.02≦q≦0.10. The transition metal may or may not be present. The provided electrode composition can be included in a lithium-ion electrochemical cell. When y =0, 0≦q≦0.43, 0.08≦x≦0.83, and 0.15≦z≦0.49.

In another aspect, a method of making an alloy for a negative electrode composition for a lithium-ion electrochemical cell is provided that includes charging a mill with a mixture comprising silicon, tin, one or more transition metal silicates, and graphite, wherein the mole fraction of silicon, tin, transition metal, and graphite are represented by q, x, y, and z in the formula SiₓSn_{q}M_{y}C_{z}, wherein q, x, and z are greater than zero, M is one or more transition metals, 0.55≦x≦0.83, 0.02≦y≦0.10, 0.25≦z≦0.35, and 0.02≦q≦0.05; ball-milling the mixture; and drying the mixture in a vacuum oven.

In the present disclosure:

“amorphous” refers to a material that lacks long range atomic order and whose x-ray diffraction pattern lacks sharp, well-defined peaks;

“cycling” refers to lithiation followed by delithiation or vice versa;

“negative electrode” refers to an electrode (often called an anode) where electrochemical oxidation and delithiation occurs during a discharging process; and

“positive electrode” refers to an electrode (often called a cathode) where electrochemical reduction and lithiation occurs during a discharging process.

The provided negative electrode compositions and methods of making the same provide high capacity negative electrodes for use in lithium-ion electrochemical cells. They expand volumetrically in a uniform manner when lithiated and thus, internal stresses of the electrode are reduced compared with conventional alloy-type negative electrodes.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIGS. 1 and 2 are x-ray diffraction patterns (XRD) of various embodiments of provided electrode compositions.

FIG. 3a is a photograph (from top side) of 64-electrode printed circuit board cell plate.

FIG. 3b is a schematic of a cross-section through printed circuit board cell plate showing connection of cell pads with charger leads.

FIG. 3c shows a lead pattern on top of printed circuit board.

FIG. 3d shows a lead pattern on the bottom of printed circuit board.

FIG. 4 is a Gibb's triangle for the Sn—Si—C system showing compositions of the Sn_{100-x-y}SiₓC_{y} libraries as determined by electron microprobe analysis.

FIG. 5a-c plots data for a typical “library closure” of provided compositions.

FIGS. 6a-6c (a) XRD patterns of selected samples from library 1, (b) dQ/dV vs. voltage for the first 3 cycles, and (c) capacity vs. cycle number, discharge capacity and charge capacity of the samples.

FIGS. 7a-7c shows the same graphs as FIGS. 6a-6c for selected samples from library 2.

FIGS. 8a-8c shows the same graphs as FIGS. 6a-6c for selected samples from library 2.

FIGS. 9a-9c show plots of capacity (mAh/g) vs. cycle number for compositions indicated from the combinatorial libraries of Sn_{100-x-y}SiₓC_{y} (a) library 1; (10≦x≦65 and y˜20), (b) library 2; (2≦x≦60 and y˜30), and (c) library 3; (5≦x≦45 and y˜45).

FIG. 10a-c are plots of potential (V) versus capacity (mAh/g) for an electrode with composition of Sn₃₄Si₄₇C₁₉ from library 1 (FIG. 10a), Sn₃₇Si₃₁C₃₂ for from library 2 (FIG. 10b) and Sn₃₅Si₂₂C₄₃ from library 3c with corresponding differential capacity curves.

FIGS. 11a-c are plots of the theoretical and observed specific capacity (mAh/g) of (a) Sn_{100-x-y}SiₓC_{y} library (10≦x≦65 and y˜20), (b) Sn_{100-x-y}SiₓC_{y} library (2<x<60 and y˜30), and (c) Sn_{100-x-y}SiₓC_{y} library (5<x<45 and y˜45).

FIG. 12 shows plots of selected Mössbauer effect spectra of samples from library 1.

FIG. 13 shows plots of selected Mössbauer effect spectra of samples from library 2.

FIG. 14 shows plots of selected Mössbauer effect spectra of samples from library 3.

FIGS. 15a-e are plots of room temperature ¹¹⁹Sn Mössbauer effect parameters of the doublet component for Sn_{100-x-y}SiₓC_{y} combinatorial library 1 (10<x<65 and y˜20) (a) quadrupole splitting, (b) center shift, and (c), relative area vs. Sn content of the Sn—Si component.

FIGS. 16a-c are plots of room temperature ¹¹⁹Sn Mössbauer effect parameters of the doublet component for Sn_{100-x-y}SiₓC_{y} combinatorial library 2 (2<x<60 and y˜30). (a) quadrupole splitting, (b) center shift, and (c) relative area vs. Sn content of the Sn—Si component.

FIGS. 17a-c are plots of room temperature ¹¹⁹Sn Mössbauer effect parameters of the doublet component for Sn_{100-x-y}SiₓC_{y} combinatorial library 3 (5<x45 and y˜45). (a) quadrupole splitting, (b) center shift, and (c) relative area vs. Sn content of Sn—Si component.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Alloys for use in negative electrode compositions for lithium-ion electrochemical cells are provided that are fully amorphous and have the formula, SiₓSn_{q}M_{y}C_{z}. The coefficients, q, x, y, and z represent mole fractions. In the provided alloys carbon is always present so that x, q, and z are always greater than zero. M can be one or more transition metals and can include metals selected from manganese, molybdenum, niobium, tungsten, tantalum, iron, copper, titanium, vanadium, chromium nickel, cobalt, zirconium, yttrium, and combinations thereof. In some embodiments, M can also include actinides and lanthanides. Due to the difficulty of separating these elements, actinides and lanthanides are typically available as mischmetals (Mm, hereinafter). Most mischmetals have a combination of actinides and lanthanides and include significant amounts of cerium. In some embodiments, the transition metal or metals can be selected from iron and titanium.

The provided alloys can have from greater than or equal to 8 mole percent (“mole %”) to less than or equal to 83 mole % silicon, from greater than or equal to 50 mole percent silicon to less than or equal to 83 mole % silicon, from greater than or equal to 55 mole % silicon to less than or equal to 83 mole % silicon, from greater than or equal to 60 mole % silicon to less than or equal to 83 mole % silicon , or even from greater than or equal to 65 mole % silicon to less than or equal to 83 mole % silicon. The provided alloys can also have from greater than 0 to about 45 mole % tin. Additionally the provided alloys can have from about 0 to about 15 mole %, from about 2 mole % to about 10 mole percent, or even from about 2 mole % to about 5 mole % transition metal, M. The provided alloys also include carbon. The carbon can be present in from greater than 0 to about 50 mole %, from about 18 mole % to about 50 mole %, from about 10 mole % to about 45 mole %, or even from about 20 mole % to about 45 mole %. In some embodiments provided alloys containing only silicon, tin, and carbon can have from about 54 mole % to less than 100% silicon, from greater than 2 to about 5 mole % tin, and from about 25 mole % to about 35 mole % carbon.

The provided negative electrode composition which can be used as an anode, or negative electrode in a lithium-ion electrochemical cell can be a composite in which a provided alloy is combined with a binder and a conductive diluent. Examples of suitable binders include polyimides, polyvinylidene fluoride, and lithium polyacrylate (LiPAA). Lithium polyacrylate can be made from poly(acrylic acid) that is neutralized with lithium hydroxide. In this disclosure, poly(acrylic acid) can include any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like. Of particular interest are polymers or copolymers of acrylic acid or methacrylic acid that are water soluble - especially after neutralization or partial neutralization. Water solubility is typically a function of the molecular weight of the polymer or copolymer and/or the composition. Poly(acrylic acid) is very water soluble and is preferred along with copolymers that contain significant mole fractions of acrylic acid. Poly(methacrylic) acid is less water soluble—particularly at larger molecular weights.

Homopolymers and copolymers of acrylic and methacrylic acid that are useful in this invention can have a molecular weight (M_{W}) of greater than about 10,000 grams/mole, greater than about 75,000 grams/mole, or even greater than about 450,000 grams/mole or even higher. The homopolymers and copolymer that are useful in this invention have a molecular weight

(M_{W}) of less than about 3,000,000 grams/mole, less than about 500,000 grams/mole, less than about 450,000 grams/mole or even lower. Carboxylic acidic groups on the polymers or copolymers can be neutralized by dissolving the polymers or copolymers in water or another suitable solvent such as tetrahydrofuran, dimethylsulfoxide, N, N-dimethylformamide, or one or more other dipolar aprotic solvents that are miscible with water. The carboxylic acid groups (acrylic acid or methacrylic acid) on the polymers or copolymers can be titrated with an aqueous solution of lithium hydroxide. For example, a solution of 34% poly(acrylic acid) in water can be neutralized by titration with a 20% by weight solution of aqueous lithium hydroxide. Typically, 50% or more, 60% or more, 70% or more, 80% or more, 90% or more, 100% or more, 107% or more of the carboxylic acid groups are lithiated (neutralized with lithium hydroxide) on a molar basis. When more than 100% of the carboxylic acid groups have been neutralized this means that enough lithium hydroxide has been added to the polymer or copolymer to neutralize all of the groups with an excess of lithium hydroxide present. Examples of suitable conductive diluents include carbon blacks.

To prepare lithium-ion electrochemical cell, a provided negative electrode or anode can be combined with an electrolyte and a positive electrode or cathode (the counter electrode). The electrolyte may be in the form of a liquid, solid, or gel. Examples of solid electrolytes include polymeric electrolytes such as polyethylene oxide, fluorine-containing polymers and copolymers (e.g., polytetrafluoroethylene), and combinations thereof. Examples of liquid electrolytes include ethylene carbonate, diethyl carbonate, propylene carbonate, fluoroethylene carbonate (FEC), and combinations thereof. The electrolyte is provided with a lithium electrolyte salt. Examples of suitable salts include LiPF₆, LiBF₄, lithium bis(oxalato)borate, LiN(CF₃SO₂)₂, LiN(C₂F₅SO₂)₂, LiAsF₆, LiC(CF₃SO₂)₃, and LiClO₄. Examples of suitable cathode compositions include LiCoO₂, LiCo_{0.2}Ni_{0.8}O₂, and LiMn₂O₄. Additional examples include the cathode compositions described in U.S. Pat. Nos. 5,900,385 (Dahn et al.); 6,680,145 (Obrovac et al.); 6,964,828 and 7,078,128 (both Lu et al.); 7,211,237 (Eberman et al.); and U. S. Pat. Appl. Publ. Nos. 2003/0108793 (Dahn et al.) and 2004/0121234 (Le).

To make a positive or a negative electrode, the active powdered material, any selected additives such as binders, conductive diluents, fillers, adhesion promoters, thickening agents for coating viscosity modification such as carboxymethylcellulose and other additives known by those skilled in the art are mixed in a suitable coating solvent such as water or N-methylpyrrolidinone (NMP) to form a coating dispersion or coating mixture. The dispersion is mixed thoroughly and then applied to a foil current collector by any appropriate dispersion coating technique such as knife coating, notched bar coating, dip coating, spray coating, electrospray coating, or gravure coating. The current collectors are typically thin foils of conductive metals such as, for example, copper, aluminum, stainless steel, or nickel foil. The slurry is coated onto the current collector foil and then allowed to dry in air followed usually by drying in a heated oven, typically at about 80° C. to about 300° C. for about an hour to remove all of the solvent.

A variety of electrolytes can be employed in the disclosed lithium-ion cell. Representative electrolytes contain one or more lithium salts and a charge-carrying medium in the form of a solid, liquid or gel. Exemplary lithium salts are stable in the electrochemical window and temperature range (e.g. from about −30° C. to about 70° C.) within which the cell electrodes can operate, are soluble in the chosen charge-carrying media, and perform well in the chosen lithium-ion cell. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary charge-carrying media are stable without freezing or boiling in the electrochemical window and temperature range within which the cell electrodes can operate, are capable of solubilizing sufficient quantities of the lithium salt so that a suitable quantity of charge can be transported from the positive electrode to the negative electrode, and perform well in the chosen lithium-ion cell. Exemplary solid charge carrying media include polymeric media such as polyethylene oxide, polytetrafluoroethylene, polyvinylidene fluoride, fluorine-containing copolymers, polyacrylonitrile, combinations thereof and other solid media that will be familiar to those skilled in the art. Exemplary liquid charge carrying media include ethylene carbonate, propylene carbonate, dimethyl carbonate, diethyl carbonate, ethyl-methyl carbonate, butylene carbonate, vinylene carbonate, fluoroethylene carbonate (FEC), fluoropropylene carbonate, y-butylrolactone, methyl difluoroacetate, ethyl difluoroacetate, dimethoxyethane, diglyme (bis(2-methoxyethyl) ether), tetrahydrofuran, dioxolane, combinations thereof and other media that will be familiar to those skilled in the art. Exemplary charge carrying media gels include those described in U.S. Pat. Nos. 6,387,570 (Nakamura et al.) and 6,780,544 (Noh). The charge carrying media solubilizing power can be improved through addition of a suitable cosolvent. Exemplary cosolvents include aromatic materials compatible with Li-ion cells containing the chosen electrolyte. Representative cosolvents include toluene, sulfolane, dimethoxyethane, combinations thereof and other cosolvents that will be familiar to those skilled in the art. The electrolyte can include other additives that will familiar to those skilled in the art. For example, the electrolyte can contain a redox chemical shuttle such as those described in U.S. Pat. Nos. 5,709,968 (Shimizu); 5,763,119 (Adachi); 5,536,599 (Alamgir et al.); 5,858,573 (Abraham et al.); 5,882,812 (Visco et al.); 6,004,698 (Richardson et al.); 6,045,952 (Kerr et al.); 6,387,571 (Lain et al.); and 7,648,801; 7,811,710; and 7,615,312 (all to Dahn et al.).

In some embodiments, the provided negative electrode compositions for a lithium-ion electrochemical cell can have the formula, SiₓSn_{q}C_{z} where y of M_{y} is zero. Because of their improved electrical conductivity compared to pure Si, Si—Sn based materials remain attractive and the synthesis of a suitable amorphous material that can effectively accommodate volume expansion and maintain good cycleablity. No comprehensive study of the effects of carbon on the Sn—Si system has been reported.

Three pseudobinary combinatorial libraries were produced by multi-target sputtering to probe the structure of various Sn—Si—C alloys. The details of the experiments are discussed in the Example section below. The combination of microprobe, x-ray diffraction, electrochemistry and Mössbauer effect spectroscopy has allowed for a consistent picture of the microstructure and resulting properties of Sn—Si—C alloys. The effects of increasing carbon content on the behavior as a function of Sn:Si ratio are clearly seen in both the electrochemical studies and Mössbauer effect spectroscopy investigations. The addition of carbon is shown to inhibit the aggregation of Sn grains. These studies indicate that Sn—Si—C alloys show promise as negative electrode materials for Li-ion cells and that the microstructure of the sputtered films can be refined by the choice of appropriate stoichiometry in order to select the appropriate capacity and corresponding overall volume change.

In another aspect, a method of making a negative electrode composition for a lithium-ion electrochemical cell is provided that includes charging a mill with a mixture comprising silicon, tin, iron silicate, graphite and a binder. The charged amounts are represented by mole fractions of q, x, y, and z in the formula, SiₓSn_{q}M_{y}C_{z}. q, x, and z are greater than zero and M is one or more transition metals such as those discussed above. In some embodiments, 0.25≦z<0.35, 0.50≦x≦0.83, and 0.02≦y≦0.10.

Objects and advantages of this invention are further illustrated by the following examples, but the particular materials and amounts thereof recited in these examples, as well as other conditions and details, should not be construed to unduly limit this invention.

### EXAMPLES

### Examples 1-3

### Amorphous Si₆₆₋ₓSn₄FeₓC₃₀

Raw Materials

Silicon (Si)—coarse powder, 99.8% purity, available from Elkem (Majorstua, Norway).

Tin (Sn)—325 mesh, 99.8% purity, available from Alfa Asear (Ward Hill, Mass.).

FeSi50—ferrosilicon, 50 weight percent silicon, <1.5 mm, available from Globe

Metallurgical (Beverly, Ohio).

TiSi₂—325 mesh, 99.5% purity, available from Alfa Aesar.

C (graphite)—TIMREX SFG-44, available from TimCal Ltd (Bodio, Switzerland).

Appropriate amounts of raw materials (see Table 1) were added to a 5L steel vessel (internal diameter of 7.4 in (18.3 cm)) along with 10 kg of 0.5 inch (1.25 cm) diameter chromium steel balls. The vessel was purged with N₂ and milled at 98 rpm (revolutions per minute) for 10 days.

TABLE 1
Alloy Compositions (Si₆₆₋ₓSn₄FeₓC₃₀)

| Exam- | Alloy | | | | | Stearic |
|---|---|---|---|---|---|---|
| ple | Composition | Si | Sn | FeSi50 | C | Acid |
| 1 | Si₆₆Sn₄C₃₀ | 68.94 g | 17.66 g | 0 g | 13.40 g | 0.30 g |
| 2 | Si₆₄Sn₄Fe₂C₃₀ | 61.67 g | 16.78 g | 7.92 g | 13.12 g | 0.30 g |
| 3 | Si₆₁Sn₄Fe₅C₃₀ | 51.30 g | 16.77 g | 19.21 g | 12.73 g | 0.30 g |

FIG. 1 shows X-ray diffraction (XRD) patterns of the alloy powders of Examples 1-3 made from the compositions in Table 1. The XRD plots showed no definite peaks indicating that all of the alloys were amorphous.

### Examples 4-7

### Amorphous Si_{66-2y}Sn₄Fe_{y}Ti_{y}C₃₀

Appropriate amounts of raw materials (see Table 1) were added to a 5L steel vessel (internal diameter of 7.4 in (18.3 cm)) along with 10 kg of 0.5 inch (1.25 cm) diameter chromium steel balls. The vessel was purged with N₂ and milled at 98 rpm (revolutions per minute) for 13 days.

TABLE 2
Alloy Compositions (Si_{66-2y}Sn₄Fe_{y}Ti_{y}C₃₀)

| Example | Alloy Composition | Si | Sn | FeSi50 | TiSi2 | C | Stearic Acid |
|---|---|---|---|---|---|---|---|
| 4 | Si₆₂Sn₄Fe₂Ti₂C₃₀ | 54.74 g | 17.04 g | 7.81 g | 7.47 g | 12.94 g | 1.00 g |
| 5 | Si₆₀Sn₄Fe₃Ti₃C₃₀ | 48.00 g | 16.75 g | 11.51 g | 11.02 g | 12.72 g | 1.00 g |
| 6 | Si₅₈Sn₄Fe₄Ti₄C₃₀ | 41.49 g | 16.47 g | 15.09 g | 14.44 g | 12.50 g | 1.00 g |
| 7 | Si₆₁Sn₄Fe₅Ti₅C₂₅ | 15.77 g | 15.77 g | 18.08 g | 17.28 g | 9.97 g | 1.00 g |

FIG. 2 shows X-ray diffraction (XRD) patterns of the alloy powders of Examples 4-7 made from the compositions in Table 2. The XRD plots showed no definite peaks indicating that all of the alloys were amorphous.

### Testing Alloys as Active Material for Reversible Lithiation/Delithiation

### Binder Formulation

Poly(acrylic acid)-Li Salt (designed as LiPAA) was made by adding LiOH solution in water to

Poly(acrylic acid) solution in water to a solution which had a 1:1 mole ratio of LiOH to acrylic acid. To make LiPAA, solutions of 20 wt % LiOH—H₂O and 34wt % Poly(acrylic acid) were mixed together. Deionized water was added to make final solution of Poly(acrylic acid)-Li salt 10 wt % solids. Poly(acrylic acid) solutions in water with Mw 250,000 were obtained from Aldrich Chemical, Milwaukee, Wis.

### Electrode Formulations for Examples 1-7

### 92 wt % Alloy Powder: 8 wt % LiPAA

1.84 g alloy powder (from Examples 1-7 above) and 1.6 g LiPAA solution (10% solids in water) were mixed in a 45-mL stainless steel vessel using four ½ inch (1.25 cm) diameter tungsten carbide balls. The mixing was done in a planetary micro mill (PULVERISETTE 7 Model; Fritsch, Germany) at speed 2 for one hour. The resulting solution was hand spread onto a 10-micron thick Cu foil using a gap die having a 3 mil (76 micrometer) gap. The sample was then dried a vacuum oven at 120° C. for 1-2 hrs.

### Test Cell Assembly

Disks of 16-mm diameter were punched off as electrodes in 2325-button cells. Each 2325 cell consisted of a 20-mm diameter disk of Cu spacer that was 30-mil (0.76 mm) thick, an 18-mm diameter disk of alloy electrode, one 20-mm diameter micro porous separators (CELGARD 2400p available from Separation Products, Hoechst Celanese Corp., Charlotte, N.C.)), 18-mm diameter Li (0.38 mm thick lithium ribbon; available from Aldrich, Milwaukee, Wis.) and an 20-mm diameter copper spacer (30-mil thick). 100 microliters of electrolyte 90 wt % (1M LiPF₆ in [1 EC:1 EMC :1DMC by wt]+10 wt % FEC) was used. (1M LiPF₆ in EC/EMC/DMC was from Ferro Chemicals (Ferro Corp., Zachary, La.) and FEC (fluoroethylene carbonate) (Fujian Chuangxin Science And Technology LTP, Fujian, China). EC was ethylene carbonate, EMC was ethyl methyl carbonate, DMC was dimethyl carbonate and FEC was 2-fluorocarbonate.

The cells were cycled from 0.005 V to 0.90 V at a specific rate of 100 mA/g-alloy with trickle down to 10 mA/g at the end of discharge (delithiation) for the first cycle. From then on, the cells were cycled in the same voltage range but at 200 mA/g-alloy and trickle down to 20 mA/g-alloy at the end of discharge. Cells were allowed 15 min rest at open circuit at the end of every half cycle. Test cell performance of these electrodes are shown in Table 3. Overall, the alloys showed reversible lithiation/delithiation for many cycles making them suitable for use as active anode material in rechargeable lithium-ion electrochemical cell applications.

TABLE 3
Alloy Composition Performance in Cells

| | | | Reversible | Irreversible | Capacity | Capacity |
|---|---|---|---|---|---|---|
| | | Density | Capacity | Capacity | (after cycle 2) | (Cycle50)/Capacity |
| Ex. | Alloy | (g/cm3) | (mAh/g) | (%) | (mAh/g) | (Cycle 2) (mAh/g) |
| 4 | Si₆₂Sn₄Fe₂Ti₂C₃₀ | 3.27 | 1074 | 20.27 | 1057 | 0.96 |
| 5 | Si₆₀Sn₄Fe₃Ti₃C₃₀ | 3.37 | 921 | 21.95 | 907 | 1.00 |
| 6 | Si₅₈Sn₄Fe₄Ti₄C₃₀ | 3.45 | 775 | 24.09 | 786 | 1.00 |
| 7 | Si₆₁Sn₄Fe₅Ti₅C₂₅ | 3.49 | 1008 | 19.23 | 990 | 0.98 |

### Sn—Si—C Combinatorial Libraries

Three pseudobinary combinatorial libraries in the Sn—Si—C system were produced using a Corona Vacuum Coater model V3-T multi-target sputtering system described in detail in J. R. Dahn, S. Trussler, T. D. Hatchard, A. Bonakdarpour, J. R. Mueller-Neuhaus, K. C. Hewitt and M. D. Fleischauer, Chem.

Materials, 14, 3519 (2002). Libraries were distinguished by their nominal compositions in Sn_{100-x-y}SiₓC_{y}, where “y” was around 20, 35, and 45. Table 4 summarizes the target compositions and deposition parameters for the three libraries. A base pressure of 1×10⁻⁷ Torr was reached prior to sputtering. Three different kinds of targets two inches (5 cm) in diameter were used: a carbon target (99.999% pure) obtained from Kurt J. Lesker Co., a tin target (99.85% pure) cut from a plate obtained from Alfa Aesar, and a silicon target (99.99% pure, Williams Advanced Materials). Prior to deposition, all substrates were first exposed to an O₂ plasma and then to an Ar plasma for 15 minutes each. To obtain the desired deposition profile, different stationary masks were placed over the targets. Deposition was carried out with a flow of 3 sccm argon. The chamber pressure was maintained at 1 mTorr of argon gas during the depositions. The sputtering table was loaded with a variety of substrates: copper disks for mass determination, a copper foil for composition analysis, a silicon (100) wafer for XRD measurement, KAPTON foils for Mössbauer measurement and a combinatorial cell plate for electrochemical testing. The angular velocity of sputtering table was 40 rpm to ensure atomic level mixing of the Si, Sn and C atoms. Continuous films on the 76 mm wide sputter track were deposited on these substrates. The three masks (one for each library) were designed to obtain (1) a constant amount of carbon throughout the library, (2) a linearly varying amount of silicon versus tin. As the sputtering table passed over the target, a layer of approximately one atom thickness was deposited which assured the atomic scale mixing of the deposition.

TABLE 4
Summary of the compositions and sputtering parameters
for the prepared combinatorial libraries.

| | | Range of Si content | | | | |
|---|---|---|---|---|---|---|
| Library | Nominal C | (x) in | Power to targets (W) | | | |
| number | content (y) | Sn_{100-x-y}SiₓC_{y} | Sn | Si | C | Pressure (mT) |
| 1 | 20 | 10 < x < 65 | 3 | 2 × 140 | 200 | 1 |
| 2 | 35 | 2 < x < 60 | 7 | 110 | 2 × 95 | 1 |
| 3 | 45 | 5 < x < 45 | 5 | 150 | 2 × 250 | 1 |

A Sartorius SE-2 microbalance (0.1 μg precision) was used to determine the position-dependence of the mass per unit area of the sputtered materials. Thin film library compositions were determined using a JEOL-8200 SUPERPROBE electron microprobe using wavelength dispersive spectroscopy (WDS) to verify that the intended composition gradients were achieved. The microprobe was equipped with a translation stage, which allowed the composition measurements to be matched with the results of other measurements. X-ray measurements were collected using an INEL CPS 120 curved position-sensitive detector coupled with an x-ray generator equipped with a copper target x-ray tube. The incident angle of the beam with respect to the sample was about 6°, which does not satisfy the Bragg condition for a silicon (100) wafer used as a substrate, allowing for zero-background measurements. The diffraction peaks (20 =6° to)120° were collected simultaneously. Acquisition time for each composition was 2400 s. The spatial resolution on the film as defined by the distance between adjacent x-ray diffraction scans in conjunction with the composition gradient in the sample yielded an uncertainty in the composition for the x-ray measurements of about ±0.5 atomic % in Si and Sn.

Room temperature ¹¹⁹Sn Mössbauer effect spectra were collected using a constant-acceleration Wissel System II spectrometer equipped with a Ca^{119m}SnO₃ source. The velocity scale of the system was calibrated relative to CaSnO₃. A lead aperture was used to select the part of the film to be investigated. The width of the aperture yielded an uncertainty in Si and Sn composition of ±2.0 atomic % for the Mössbauer measurements.

For electrochemical testing, a 64-channel electrochemical cell plate based on a resin-based printed circuit board as illustrated in FIGS. 3a-d was used. Details of this cell plate design can be found in M. A. Al-Maghrabi, N. van der Bosch, R. J. Sanderson, D. A. Stevens, R. A. Dunlap, and J. R. Dahn, Electrochem. Solid-State Letters, 14, 1 (2011). A combinatorial electrochemical cell was constructed as described by M. D. Fleischauer, T. D. Hatchard, G. P. Rockwell, J. M. Topple, S. Trussler, S. K. Jericho, M. H. Jericho and J. R. Dahn, J. Electrochem. Soc., 150, A1465 (2003). Slow scan cyclic voltammetry measurements were performed on the 64 channels of the cell plate using a multichannel pseudopotentiostat as described by V. K. Cumyn, M. D. Fleischauer, T. D. Hatchard and J. R. Dahn, Electrochem. Solid-State Letters 6, E15, (2003). Cells were discharged/charged between 1.2 and 0.005 V vs. Li/Li⁺ for a total of 27 cycles. The scan time was 12 hours for each discharge or charge during the first three cycles, 3 hours during cycles 4-24 and 12 hours again for cycles 25, 26 and 27. This was done so that changes to the electrode which may have occurred during 27 cycles could be carefully monitored by comparing slow cyclic voltammetry measurements take in the first three and last three cycles.

FIG. 4 shows a Gibb's triangle for the Sn—Si—C system showing the compositions of the three prepared libraries (see Table 4). This figure shows that libraries with varying Sn and Si content and with an approximately constant amount of carbon were obtained. The shaded area in the figure indicates the amorphous range as determined from X-ray diffraction. Materials were judged to be amorphous when the x-ray patterns displayed no sharp diffraction peaks, only broad amorphous-like “humps”.

Compositions as obtained from microprobe analysis were confirmed by “library closure” (see, for example, P. Liao, B. L. MacDonald, R. A. Dunlap and J. R. Dahn, Chem. Mater., 20, 454 (2008)) as shown in FIG. 5. In this figure the composition and mass per unit area of a typical library as a function of position along the library is plotted. FIG. 5a shows moles per unit area of C (open diamond), Sn (solid triangle), and Si (solid squares) defined by “constant”, “linear in” and “linear out” sputtering masks, respectively. FIG. 5b shows that the compositions calculated from FIG. 5a agree with the compositions measured by wavelength dispersive spectroscopy.

FIG. 5c compares the measured mass of the sputtered films on each weighing disk (open circle) with the calculated mass from the curves in FIG. 5a (solid line) for a Sn_{100-x-y}SiₓC_{y} library (10<x≦65 and y is about 20). The other two libraries showed similar results.

FIGS. 6a-6c show the results of x-ray diffraction (XRD) studies of the three libraries (summarized in Table 4) that are presented in this work. The composition of each sample is indicated. FIG. 6a shows selected diffraction patterns that cover the composition range of Sn_{100-x-y}SiₓC_{y} in library 1. For the compositions studied in the present work, an amorphous or nanostructured phase was found for tin content in the range of 8≦(100-x-y)≦43. FIG. 7 shows the diffraction patterns for library 2 where the amorphous or nanostructured range was found to be between 7≦(100-x-y)≦37. This range was extended in library 3 as shown in FIGS. 8, to 5≦(100-x-y)≦42. In all these ranges the thin films had broadened peaks centered at 2θ=29 and 44°, which closely matched the reflections of amorphous or nanostructured silicon reported previously in T. D. Hatchard and J. R. Dahn, J. Electrochem. Soc., 151, A1628 (2004).

As found in previous work (see, for example, the Hatchard and Dahn reference cited above) this region (amorphous) certainly extends to lower Sn content and would include the (100-x-y)=0 axis. As the amount of tin exceeded a certain percentage, (100-x-y)≧51 (100-x-y)≧46 and (100-x-y) >48 for libraries 1 to 3, respectively, diffraction peaks appeared at 2θ=30.6°, 32.0°, 44.0°, and 45.0° peaks, corresponding to the (200), (101), (220), and (211) reflections of crystalline tin (tetragonal, I41/amd). Library 3 had the largest range of compositions that were found to be amorphous or nanostructured. The Sn-rich limit of the amorphous range varied systematically with C content and corresponded to Sn:Si atomic ratios of ˜1:1, 1.2:1 and 3:1, respectively, in libraries 1 through 3. Beaulieu et al., J. Electrochem. Soc., 150, A149 (2003), studied the structure of Si₁₀₀₋ₓSnₓ electrodes prepared by the sputtering method. They reported that the amorphous phase of Si₁₀₀₋ₓSnₓ was found in samples with x≦36, which corresponds to a 0.8:1 ratio of Sn:Si. It has been reported that the amorphous range of a Si₁₀₀₋ₓSnₓ sputtered film was obtained when 0≦x≦50 (corresponding to a 1:1 ratio). These measurements indicate that the amorphous ranges extends downward (in carbon content) from the region studied in the present work to the line on the y=0 (no carbon) axis as illustrated in FIG. 4. Comparing the reported Sn: Si ratios from these previous reports with those obtained in the present study shows that the carbon content plays a role in extending the amorphous range. Although there is a possibility of forming SiC, no peaks for crystalline silicon carbide were observed for any of our samples. Generally, the present results show that a substantial portion of the compositions prepared in this work are amorphous or nanostructured and, from a structural standpoint, show potential for use as electrode materials.

FIGS. 7b, 7b, and 8b show selected differential capacity vs. potential plots for the three Sn_{100-x-y}SiₓC_{y} combinatorial libraries. The composition of each sample is indicated. The first three cycles are shown. Close inspection of the results for libraries 1, 2, and 3 shows smooth curves with broad humps for 8≦(100-x-y)≦43, 7≦(100-x-y)≦37, and 5≦(100-x-y)≦42, respectively, during both discharge and charge. Such a profile is similar to the characteristics of amorphous sputtered silicon thin films and suggests that little crystalline tin was present in the present samples. XRD patterns for these compositions show that the materials were amorphous or nanostructured. Sharp peaks in the differential capacity vs. voltage curves were observed for crystalline portions of each library. Generally, the sharp peak in the differential capacity vs. potential curves is an indicator of the presence of crystalline Sn and the corresponding panels in the figures showing XRD patterns confirmed that crystalline tin was present. It seems that there is a transition point where the dispersed tin within the silicon and carbon matrix starts to aggregate, forming regions of crystalline tin.

FIGS. 6c, 7c, and 6c show the specific capacity vs. cycle number for the same samples shown in panels (a) and (b). FIG. 6c shows that the capacity of cells degraded rapidly for compositions that were: 1) found to contain crystalline tin as evidenced by XRD patterns and in the differential capacity vs. potential curves (towards the bottom of the panel) and 2) in Si-rich regions of where oxygen concentrations were found to be high (towards the top of the panel) Electron microprobe measurements of the samples found that Si-rich regions have more oxygen content compared to other regions in the library. Elsewhere, the capacity remained within 90% of the initial value after about 27 cycles. Such degradation could also be a result of mechanical cracking caused by volume expansion during cycling since these electrodes do not contain any carbon black or binder. FIGS. 9a to 9c show the capacity vs. cycle numbers for libraries 1 to 3, respectively. Upon close inspection of these plots, the following remarks can be made: 1) most of the samples did not suffer from high irreversible capacity in the first cycles, which is a common problem that has been reported in literature studies, especially with alloy negative electrodes, and 2) undesirable capacity loss is associated with compositions in both Si- and Sn-rich regions, as discussed above.

FIG. 10 shows plots of potential vs. capacity for the best performing cell from library 1 (Sn₃₄Si₄₇C₁₉), library 2 (Sn₃₇Si₃₁C₃₂) and library 3 (Sn₃₅Si₂₂C₄₃). The figure also shows the differential capacity vs. potential for the first 3 cycles and the last three cycles of the same cells. FIG. 10a clearly shows smooth and stable charge and discharge curves with no plateaus. As shown in the figure, the capacity achieved for this cell was 1450 mAh/g. The electrochemical performance of a composition similar is to that shown in FIG. 10a, but containing no carbon. Although the capacity for this composition was about 2000 mAh/g, substantial capacity fade was observed after only 10 cycles. FIG. 10b shows excellent capacity retention for the sample from library 2. The stability of this composition during discharge and charge is reflected by the smooth curve during charge and discharge, with a capacity of 1060 mAh/g after 27 cycles. The same discussion is applicable to library 3, as can be seen from FIG. 10c.

Knowing the phases present in the active material make it possible to understand the measured values of specific capacities. Most of the literature does not compare the obtained capacity with that predicted for the expected phases. FIGS. 11a to 11c present the theoretical capacities for the first charge (removing lithium) for the selected electrodes from the 3 libraries, respectively, as discussed above.

FIG. 11 shows the measured capacity (solid circles) and theoretical capacity (solid triangles) assuming that Li₁₅Sn₄, Li₂₂Sn₄ and LiC₆ are the fully lithiated room temperature phases for Si, Sn, and C, respectively, as well as the theoretical capacity (solid lines) assuming Li₁₅Si₄ and Li₂₂Sn₄ are fully lithiated room temperature phases of Si and Sn, respectively, and that carbon has negligible capacity. FIG. 11a shows there is reasonable agreement between the theoretical and the observed values, particularly for high Sn content. As the Sn content is decreased, particularly in libraries 2 and 3, where the carbon content is higher, the observed capacity falls far below the theoretical capacity. It is probable that this decreased capacity is the result of the formation of nanocrystalline SiC which is inactive.

FIG. 12 shows room temperature ¹¹⁹Sn Mössbauer effect spectra for the samples from library 1, which have approximately 20% carbon, with the indicated compositions. These have been fitted to two Lorentzian components; a singlet from an essentially pure Sn phase with a center shift of +2.54 mm/s and a quadrupole split doublet with a less positive center shift, resulting from a Si-Sn phase. As amount of tin increased across the library, the singlet peak, corresponding to the tin phase, increased in intensity at the expense of the Sn—Si phase. This is presumably due to the increased aggregation of tin regions in the carbon matrix. It is apparent that even for very small tin concentrations, tin regions are present.

FIG. 13 shows the ¹¹⁹Sn Mössbauer effect spectra for samples from library 2, which has roughly 30% carbon, with the indicated compositions. Spectra collected from samples with 46 at % Sn or less were well fit to one doublet. For larger concentrations of tin, the aggregation of tin is evidenced by the appearance of the singlet component in the spectra. The small feature present in the tin-rich region of the library corresponds to a small amount of tin oxide, as represented by a Lorentzian singlet component with a center shift of near 0 mm/s. It is clear from FIG. 13 that the aggregation of Sn was inhibited up to the 46% Sn. This suggests that the addition of carbon plays an important role in defining the microstructure of the sample.

FIG. 14 shows the ¹¹⁹Sn Mössbauer effect spectra for samples from library 3, which has roughly 45% carbon, with the indicated compositions. Close inspection of these spectra shows that, in addition to the doublet component of Sn—Si phase, there is only a very small singlet component from pure tin. According to the shown trend in the previous two libraries, the increase in carbon content has further inhibited the aggregation of tin. It is possible that the formation of SiC as suggested above on the basis of electrochemical studies may ultimately limit the ability of carbon to totally eliminate the possibility of free tin formation by binding up Si and forcing Sn out of the resulting Sn:Si phase.

FIGS. 15 to 17 show the quadrupole splitting, centre shift, and relative area of Sn—Si component of libraries 1 to 3, respectively. FIG. 15 shows a decrease in the quadrupole splitting and an increase in the center shift as a function of Sn content in the library which gives evidence of changes to the short-range ordering within the amorphous Sn—Si. This can be explained as the following: If there is a replacement of Sn—Si neighbor pairs by Sn-Sn neighbor pairs, a more positive center shift would be observed, where the center shift of Sn in Si (+1.88 mm/s) is less positive than the center shift of Sn in Sn (+2.54 mm/s) The replacement of Sn—Si bonds with Sn—Sn bonds would result in a more symmetric Sn environment and would correspond to decrease in the quadrupole splitting. A symmetric Sn environment corresponds to zero quadrupole splitting. This observation is consistent with what was observed for the other two libraries as illustrated in FIG. 16 and FIG. 17.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A negative electrode composition for a lithium-ion electrochemical cell comprising an alloy having the formula SiₓSn_{q}M_{y}C_{z}, wherein q, x, y, and z represent mole fractions, q, x, and z are greater than zero, and M is one or more transition metals,
wherein the alloy is amorphous.

2. A negative electrode composition for a lithium-ion electrochemical cell according to claim 1, wherein the transition metal or metals is selected from manganese, molybdenum, niobium, tungsten, tanatalum, iron, copper, titantium, vanadium, chromium, nickel, cobalt, zirconium, yttrium, mischmetal, and combinations thereof

3. A negative electrode composition for a lithium-ion electrochemical cell according to claim 2, wherein the transition metal or metals is selected from iron and titanium.

4. A negative electrode composition for a lithium-ion electrochemical cell according to claim 1, wherein 0.50≦x≦0.83.

5. A negative electrode composition for a lithium-ion electrochemical cell according to claim 4, wherein 0.55≦x≦0.83.

6. A negative electrode composition for a lithium-ion electrochemical cell according to claim 5, wherein 0.58≦x≦0.66.

7. A negative electrode composition for a lithium-ion electrochemical cell according to claim 1, wherein 0≦y≦0.15.

8. A negative electrode composition for a lithium-ion electrochemical cell according to claim 7, wherein 0.02≦y≦0.10.

9. A negative electrode composition for a lithium-ion electrochemical cell according to claim 1, wherein 0.18≦z≦0.50.

10. A negative electrode composition for a lithium-ion electrochemical cell according to claim 9, wherein 0.25≦z≦0.35

11. A negative electrode composition for a lithium-ion electrochemical cell according to claim 1, wherein 0≦q≦0.45

12. A negative electrode composition for a lithium-ion electrochemical cell according to claim 11, wherein 0.02≦q≦0.05.

13. A negative electrode composition for a lithium-ion electrochemical cell according to claim 11, wherein the transition metal or metals is selected from iron and titanium.

14. A negative electrode composition for a lithium-ion electrochemical cell according to claim 1, wherein y=0.

15. A negative electrode composition for a lithium-ion electrochemical cell according to claim 14, wherein 0≦q≦0.43, 0.08≦x≦0.83, and 0.18≦z≦0.50.

16. A negative electrode composition for a lithium-ion electrochemical cell according to claim 1 further comprising a binder.

17. A negative electrode composition for a lithium-ion electrochemical cell according to claim 16, wherein the binder is lithium polyacrylate.

18. A lithium-ion electrochemical cell comprising a negative electrode composition according to claim 1.

19. A method of making an alloy for a negative electrode composition for a lithium-ion electrochemical cell comprising:
charging a mill with a mixture comprising silicon, tin, transition metal silicates, and graphite, wherein the mole fraction of silicon, tin, one or more transition metals, and graphite are represented by q, x, y, and z in the formula SiₓSn_{q}M_{y}C_{z}, wherein q, x, and z are greater than zero, M is one or more transition metals, 0.50≦x≦0.83, 0.02≦y≦0.10, 0.25≦z≦0.35, and 0.02≦q≦0.05;
ball-milling the mixture; and
drying the mixture in a vacuum oven.
